(19) United States
(12) Patent Application Publication
(10) Pub. No.: US 2025/0368245 A1
(43) Pub. Date: Dec. 4, 2025

(54) RETRACTABLE, SLIDING STEP-STOOL APPARATUS AND METHODS OF USE

(71) Applicant: Dan Wilford Dansie, Payson, UT (US)

(72) Inventor: Dan Wilford Dansie, Payson, UT (US)

(21) Appl. No.: 19/224,760

(22) Filed: May 31, 2025

Related U.S. Application Data
(60) Provisional application No. 63/654,959, filed on Jun. 1, 2024.

(51) Int. Cl. B62B 5/08; B62B 3/14

(52) U.S. Cl. CPC B62B 5/087; B62B 3/14

(57) ABSTRACT

A step-stool system that is connected to a shopping cart. The step-stool system includes a platform that has a stowed position and a deployed position. When the platform is in the deployed position, a person may stand on the platform to reach items on higher shelves in a store. When the platform is in the stowed position, the shopping cart can nest with other shopping carts.

### CROSS-REFERENCE TO RELATED APPLICATIONS

This application claims the benefit of U.S. Provisional Patent Application Ser. No. 63/654,959, filed on Jun. 1, 2024, which is hereby incorporated by reference in its entirety.

### THE FIELD OF THE INVENTION

This invention relates to a system wherein a retractable, sliding, step-stool is attached to a shopping cart. The step-stool system is attached to a shopping cart in a manner that allows the step-stool to be retracted, or extended, in a manner that deploys the step-stool for use.

### BACKGROUND OF THE INVENTION

Shopping carts are commonly used in a variety of stores, including grocery stores, home goods stores, craft stores, and the like. Generally, a shopping cart serves one purpose: to help a person, or shopper, carry and transport items selected for purchase.

A step-stool is commonly used to allow a person to gain an elevated position in order to more easily perform some task. For example, a step-stool could be used to help a person change a light bulb in a ceiling light fixture. A step-stool can have a variety of uses.

It would be an advance in the art to combine a step-stool system with a shopping cart in a manner that allows a person to use the step-stool to reach items that are on higher shelves. It would also be an advance in the art if the step-stool system is connected to the shopping cart in a manner that allows the shopping cart to merge, or “nest,” with other shopping carts, which other shopping carts may or may not include the step-stool system.

### SUMMARY OF THE INVENTION

The system may be described as comprising a retractable, sliding, step-stool that may be used with a shopping cart and enables shoppers to reach items on higher shelves. In one embodiment, a platform is slidable or extendable from under the shopping cart and legs are extendable from the platform so that a person may stand on the platform. The step-stool system may be described as having a stowed position and a deployed position. In the stowed position, the step-stool fits under the shopping cart in a manner that does not impede the person's use of the shopping cart. In the deployed position, the step-stool provides a platform on which a person may stand, thereby elevating the person and enabling the person to reach items that may be on a higher shelf. In the deployed position, the step-stool also provides a platform on which a person may sit. In the deployed position, the platform may be used for any suitable purpose.

The installation of the step-stool system does not prevent the usual “nesting” of shopping carts, or the ability to connect or merge shopping carts with each other. The step-stool system may be connected to a shopping cart under and adjacent to the bottom of the shopping cart. In this position under the bottom of the shopping cart, the step-stool system will not prevent the front of the shopping cart from engaging the hinged back of another shopping cart and swinging that hinged back upwards so that the front of the shopping cart can “nest” into the other shopping cart.

In one embodiment, a step-stool apparatus for a shopping cart may comprise a platform, at set of two rails connected to the shopping cart and slidably connected to the platform, and at least two legs hingedly connected to the platform. The platform may have a stowed position and a deployed position. The shopping cart can still nest with other shopping carts. The step-stool apparatus may have a spring connected between the platform and the legs to urge the legs to a stored position under the platform.

In one embodiment, a step-stool apparatus may comprise a platform, a means for slidably connecting the platform to a shopping cart in a manner that allows the platform to slide between a stowed position under the shopping cart and a deployed position out from under the shopping cart, and in a manner that allows the shopping cart to nest with other shopping carts, and at least two legs hingedly connected to the platform in a manner that allows the legs to move between a stored position under the platform and an extended position out from under the platform. The legs may also comprise a brace perpendicularly connected to each of the legs. The step-stool apparatus may also comprise a bias member connected to the platform and at least one of the legs in a manner that urges the legs to the stored position, wherein the bias member is selected from the group consisting of a spring, a gas cylinder, and an elastic.

In one embodiment, an apparatus may comprise a set of two rails connected to a shopping cart and slidably connected to a platform, wherein the slidable connection between the rails and the platform is selected from the group consisting of rail and track systems, drawer slides, telescopic slides, and slidable bolt-assembly connections, and wherein the slidable connection between the rails and the platform enables the platform to have a stowed position and a deployed position, and wherein the shopping cart can nest with other shopping carts, and at least two legs hingedly connected to the platform, and a brace perpendicularly connected to each of the legs so that each of the legs is moved in unison, and a handle perpendicularly connected to one of the legs. The apparatus may also comprise a bias member connected to the platform and at least one of the legs, wherein the bias member is selected from the group consisting of a spring, a gas cylinder, and an elastic.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is an upper, perspective view of a shopping cart with a step-stool system in a deployed position;

FIG. 2 is a side view of a shopping cart with a step-stool system in a stowed position;

FIG. 3 is an upper, perspective view of a shopping cart with a step-stool system in a stowed position;

FIG. 4 is a side view of a shopping cart with a step-stool system in a deployed position;

FIG. 5 is a top view of a shopping cart with a step-stool system in a deployed position;

FIG. 6 is a side view of a shopping cart with a step-stool system in a deployed position;

FIG. 7 is a perspective view of a shopping cart with a step-stool system in a deployed position;

FIG. 8 is a rear, perspective view of a shopping cart with a step-stool system in a stowed position;

FIG. 9 is a side, perspective view of a shopping cart with a step-stool system in a deployed position; and

FIG. 10 is a side view of two shopping carts, each having a step-stool system, in a nested configuration.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of systems and methods in accordance with the invention. The illustrated embodiments will be best understood by reference to the drawings, wherein like parts are designated by like numerals throughout.

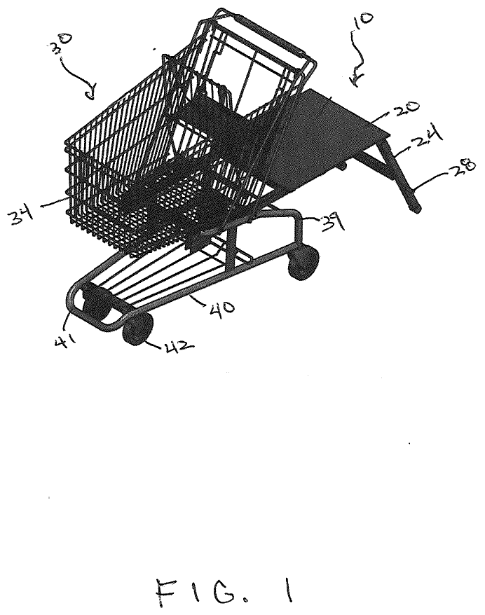

Referring to FIG. 1, a step-stool system 10, or step-stool apparatus 10, may be operably connected to a shopping cart 30. The step-stool system 10 may be operably connected so as to have a stowed position for the step-stool system 10 and a deployed position for the step-stool system 10.

The step-stool system 10 may be comprised of any suitable number of components so that the step-stool system 10 functions as intended. In one embodiment, a step-stool system 10 may include a platform 20, a rail mount 22, or track 22, at least one leg 24, and a spring 26. The rail mount 22 may be connected to the cart 30 in any suitable manner that allows the platform 20 to be retracted and extended, or allows the platform 20 to be stowed and deployed. The platform 20 may include legs 24 that are hingedly connected to the platform. The step-stool system 10 may also include a spring 26, or bias member 26, that is operably connected between the platform 20 and the legs 24 in a manner that urges the legs 24 to be retracted under the platform 20. The legs 24 may include a handle 28 that protrudes from the leg 24, generally perpendicularly, so that the handle 28 may be used to manipulate the position of the legs 24, or store and extend the legs 24 relative to the platform 20.

A shopping cart 30 may be any typical shopping cart 30 having a relatively standard configuration. For example, a shopping cart 30 may be described as including a cart portion that is generally bounded by a front 34, two walls 36, a bottom 38, and a hinged back 32. The cart portion is usually comprised of a cage-like material, or vented material, that can hold numerous items or various sizes. The hinged back 32 may swing inward and upward in a manner that allows the front 34 of another cart 30 to be positioned inside the cart portion, thus “nesting” the carts. The shopping cart 30 may further include a base 40 with wheels 42. The base 40 may be described as having a nose 41 toward the front of the base 40. The shopping cart 30 may further include supports 39 and beams 37 that provide structural support between the cart portion and the base, and also provide a space where larger items may be placed on the base 40 of the cart 30.

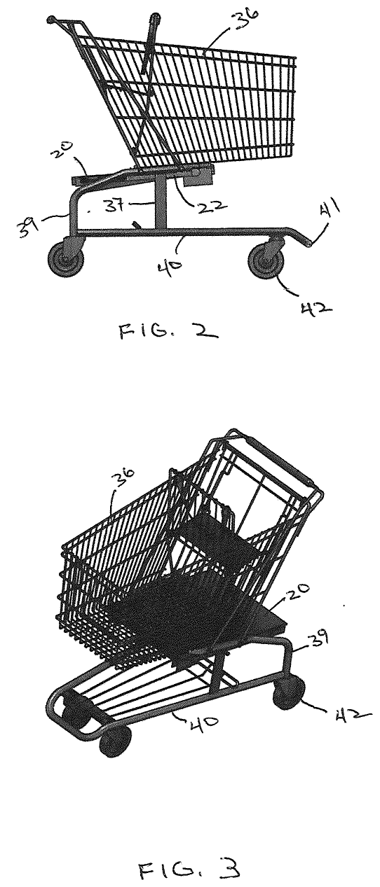

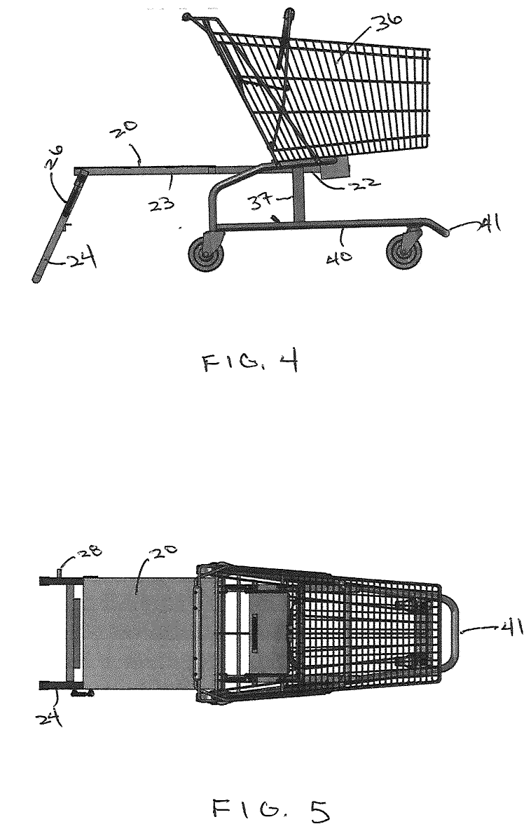

Referring to FIGS. 2 and 3, a step-stool system 10 may be operably connected to a shopping cart 30, where the step-stool system 10 is in a stowed position. In one embodiment, a mount 22, or track 22, may be operably connected to the base support 39, the beam 37, the bottom 38 of the cart, or any combination thereof. The connection may be accomplished by any suitable connection means, including without limitation, welding, soldering, bolting, mechanical fasteners, adhesives, or the like. The connection may be accomplished using a connection means that is most compatible with the structure and/or composition of the cart 30. In other words, the connection means can be selected based on which means will properly secure the mount 22 to the appropriate structures of the cart, taking into account the position, composition, and function of both the mount 22 and the structures to which it will be connected. The connection of the rail mount 22 is done in a manner that allows the platform 20 to slide along the mount 22, or relative to the mount 22. The platform 20 may be operably connected, or slidably connected, to the mount 22. The connection of the step-stool system 10, or the rail mounts 22 of the system 10, may be described as adjacent to and essentially parallel to the bottom 38. The step-stool system 10 may be positioned between the bottom 38 and the base 40, proximate the bottom 38, in any manner that does not prevent nesting of the shopping cart with other shopping carts. The connection of the step-stool system 10, of the rail mounts 22 of the system 10, may be facilitated by the incorporation of additional, structural components to the base support 39, the beam 37, the bottom 38 of the cart, or any combination thereof. Put another way, additional, structural components may be configured and connected to any part of the cart 30 in a manner that helps operably connect the rail mounts 22, or the step-stool system 10, to the shopping cart 30.

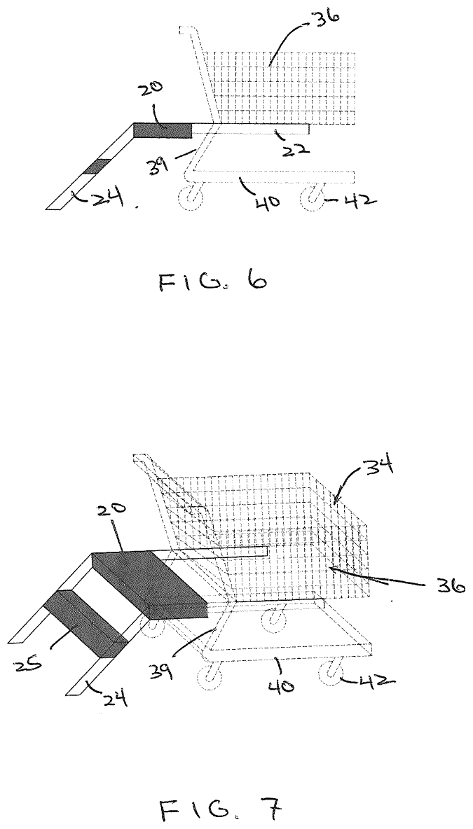

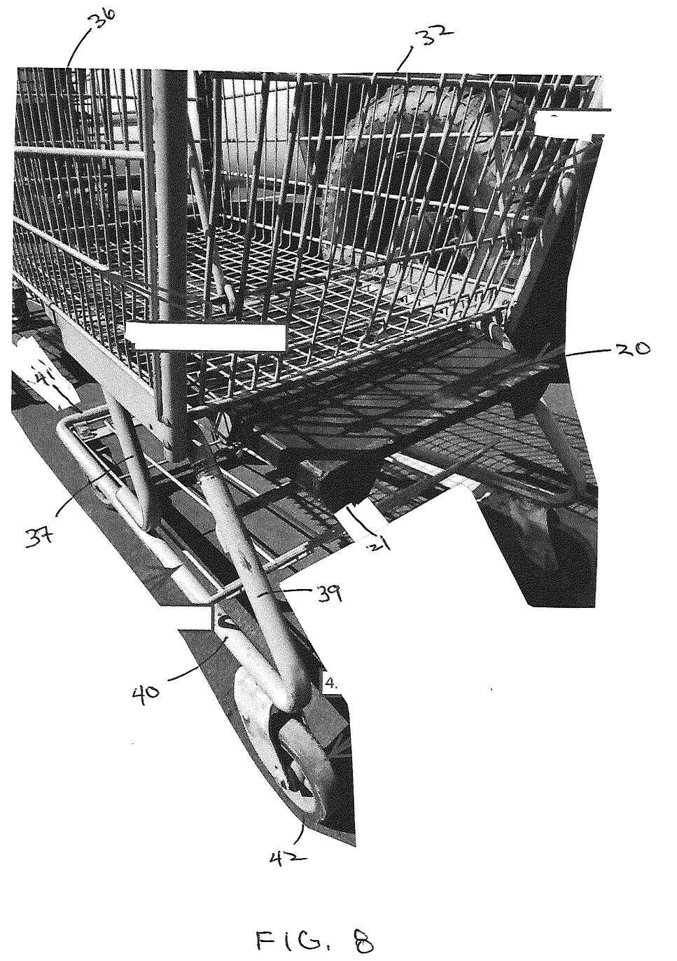

Referring to FIGS. 4 and 5, and generally to FIGS. 6, 7 and 9, a step-stool system 10 may be operably connected to a shopping cart 30, where the step-stool system 10 is in a deployed position. In one embodiment, a mount 22, or track 22, may be operably connected to the base support 39, the beam 37, the bottom 38 of the cart, or any combination thereof. A rail 23 may be operably connected, or slidably connected, to the mount 22, or track 22.

In one embodiment, a slidable means of connection between the mount 22 and the platform 20 may include any suitable slidable connection means, including without limitation, rail and track systems, drawer slides, telescopic slides, slidable bolt-assembly connections, and the like. In a separate embodiment, a slidable means of connection between the mount 22 and the rail 23 may include any suitable slidable connection means, including without limitation, rail and track systems, drawer slides, telescopic slides, slidable bolt-assembly connections, and the like.

The rail 23 may be operably connected to the platform 20. Generally, this connection between a rail 23 and a platform 20 may be rigidly secure so that the platform 20 and the rail 23 move in unison and relative to the mount 22, or track 22. However, the connection between a rail 23 and a platform 20 may be slidable to allow for even further extension of the platform 20 relative to the rail 23. Similarly, any suitable slidable connection means may be used.

The components of a step-stool system 10 may be comprised of any suitable material, including without limitation, stainless steel, titanium alloys, aluminum alloys, alloy steel, polycarbonate, acrylic, high-density polyethylene, high-impact polystyrene, PTFE, and the like. The components of a step-stool system 10 may be comprised of the same material throughout the system, or individual components may be comprised of separate materials. For example, and not by way of limitation, a mount 22 may be comprised of a titanium alloy while a rail 23 and platform 20 may be comprised of an aluminum alloy. Similarly, a mount 22 may be comprised of high-density polyethylene while a platform 20 may be comprised of polycarbonate. Further, a mount 22 may be comprised of stainless steel while a platform 20 is comprised of PTFE. The selection of various materials that may be used for individual components of a step-stool system 10 may be based on the composition of the cart 30 structures to which the individual components may be connected.

The components of a step-stool system 10 may be configured in any suitable size and shape. The size and shape of each individual component may be selected based on the function of each component, its connection to other components, and its suitability to the purpose and function of the step-stool system 10. For example, the size of a platform 20 should be large enough that a person can safely stand on the platform 20 when it is in the deployed position, but also small enough to fit under the bottom 38 of the shopping cart 30 when the platform 20 is in the stowed position. The mounts 22 and rails 23 should be long enough to enable the sliding of the platform 20 from under the bottom 38 of the cart 30 to a deployed position far enough past the hinged back 32 to allow for a person to stand on the platform 20, but also short enough to not interfere with the nesting of the shopping carts 30.

In one embodiment, a platform 20 may include a pad or non-slip cover to prevent a person from slipping or sliding while standing on the platform 20. In one embodiment, a platform 20 may include an advertisement, logo, trademark, or the like.

In one embodiment, one or more legs 24 may be hingedly connected to a platform 20 in a manner that allows the legs 24 to be stored under the platform 20, especially when the platform 20 is in a stowed position. As the platform 20 is extended out from under the bottom 38 of the cart 30, the legs 24 may be extended so that the legs 24 contact the ground or floor and support the platform 20. A handle 28 may be connected to one or more legs 24 so that the handle 28 can be used to extend the legs 24 and store the legs 24. The handle 28 may be as simple as a peg that extends perpendicularly from a leg 24 and allows a person to manipulate the legs 24. The handle 28 may be of any suitable size and configuration.

In one embodiment, one or more of the legs 24 may include a nylon pad, or a plastic cap, at the bottom to prevent scratching or other damage to floors. For example, and not by way of limitation, a “stick” of nylon may be inserted inside, or connected to, the legs 24 with a portion of the nylon extending beyond the end of the legs 24 to provide protection between the legs 24 and the floor. The nylon may also serve to prevent slippage between the legs 24 and the floor. The nylon may be secured using any suitable means, including without limitation, Allen screws, adhesives, or the like.

In one embodiment, shown more particularly in FIGS. 6 and 7, the legs 24 may include a step 25, or brace 25, extending perpendicularly between the legs 24 having each end of the brace 25 securely connected to a leg 24. Thus, a brace 25 may serve as additional support to the legs 24, connecting the legs 24 so that the legs can be moved in unison. The brace 25 may also be configured to serve as a step 25, allowing a person to step from the floor to the step 25 and then to the platform 20.

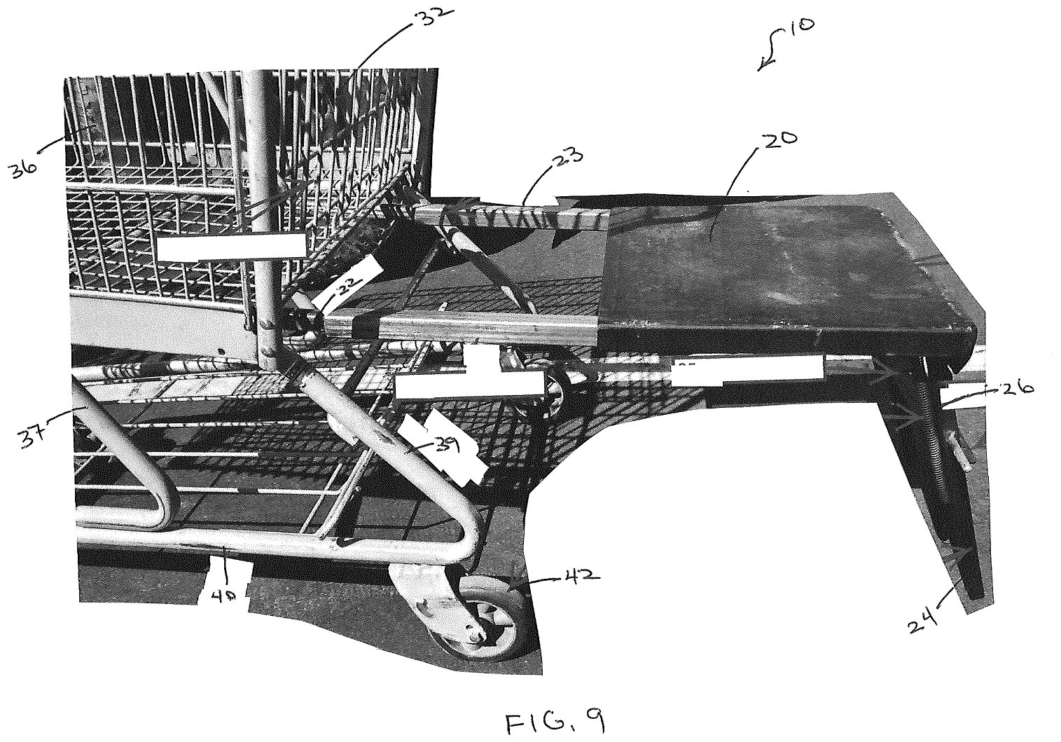

In one embodiment, shown more particularly in FIG. 8, a platform 20 may include one or more tabs 21. A tab 21 may extend perpendicularly down from the platform 20 to make it easier for a person to grasp and manipulate the platform 20. A tab 21 may be pulled to extend the platform 20 to a deployed position. A tab 21 may be pushed to retract the platform 20 back to a stowed position.

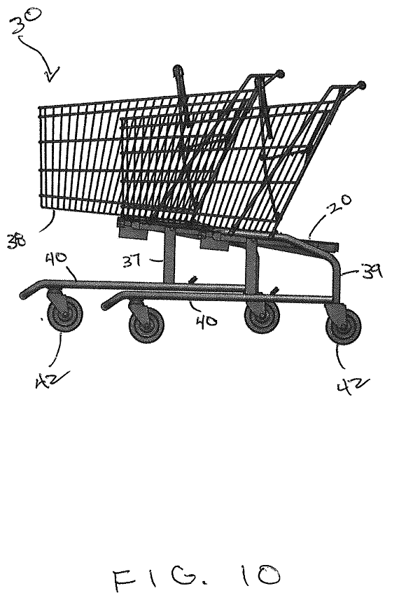

In one embodiment, shown more particularly in FIG. 9, a spring 26, or bias member 26, may be operably connected between the platform 20 and at least one leg 24. The spring 26 may have a suitable tension that allows the legs 24 to be extended out from under the platform 20, but also urges the legs 24 to retract back under the platform. For example, when the platform 20 is in a deployed position, the platform 20 may be slightly raised so that the legs 24 lose contact with the floor, thereby allowing the spring 26 to retract the legs 24 back under the platform 20. Any suitable biasing means may be utilized, including without limitation, a steel spring, a gas cylinder, a gas strut, a hydraulic rod, an elastic, or the like.

In one embodiment, a step-stool system 10 may utilize a handle 28 and a spring 26. Thus, the legs 24 may be extended from under the platform 20 in a deployed position using the handle 28, while the legs 24 may be retracted back under the platform 20 using the spring 26. However, various embodiments may utilize just the handle 28 to manipulate the legs 24, just a spring 26, or neither.

Referring to FIG. 10, two or more carts 30 may be “nested” together, even when one or more of the carts 30 are equipped with a step-stool system 10. The step-stool system 10 is relatively thin. For example, a step-stool system 10 connected to a cart 30 under the bottom 38 of the cart may only extend an additional inch to inch-and-a-half further below the bottom 38. Also, the step-stool system 10 may be connected near the back of the cart 30. Thus, the step-stool system 10 does not impede the front 34 of a first cart from contacting the hinged back 32 of a second cart, swinging that hinged back 32 upwards to allow the front 34 of the first cart to move into the cart portion of the second cart and allow for nesting of the carts. Multiple carts can be nested, or merged, regardless of whether adjacent carts include a step-stool system 10.

A method of use may be described as including the following steps: a step-stool system may be provided, wherein the step-stool system may comprise a platform operably and slidably connected to a shopping cart under the bottom of the shopping cart and the platform comprises at least one leg hingedly connected to the platform; sliding the platform out from under the shopping cart; extending the leg out from under the platform in a manner that supports the platform relative to a floor; standing, by a person, on the platform; retracting the leg back under the platform; and sliding the platform back under the shopping cart.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

What is claimed and desired to be secured by United States Letters Patent is:

1. A step-stool apparatus for a shopping cart, comprising:
a platform;
a set of two rails connected to the shopping cart adjacent to and essentially parallel to a bottom of the shopping cart and slidably connected to the platform; and
at least two legs hingedly connected to the platform.

2. The step-stool apparatus of claim 1, wherein the platform has a stowed position and a deployed position.

3. The step-stool apparatus of claim 2, wherein the shopping cart can nest with other shopping carts when the platform is in the stowed position.

4. The step-stool apparatus of claim 3, further comprising a gas strut connected between the platform and the legs to urge the legs to a stored position under the platform.

5. The step-stool apparatus of claim 3, further comprising a handle connected to at least one of the legs.

6. The step-stool apparatus of claim 3, further comprising a brace perpendicularly connected between the legs.

7. The step-stool apparatus of claim 6, wherein the brace serves as a step.

8. The step-stool apparatus of claim 3, further comprising a non-slip pad connected to the platform.

9. The step-stool apparatus of claim 3, wherein the slidable connection between the platform and the rails is a rail and track system.

10. A step-stool apparatus, comprising:
a platform;
means for slidably connecting the platform to a shopping cart in a manner that allows the platform to slide between a stowed position under a bottom of the shopping cart and a deployed position out from under the bottom of the shopping cart, and in a manner that allows the shopping cart to nest with other shopping carts; and
at least one leg hingedly connected to the platform in a manner that allows the leg to move between a stored position under the platform and an extended position out from under the platform.

11. The step-stool apparatus of claim 10, further comprising at least two legs and a brace perpendicularly connected to each of the two legs in a manner that allows the legs to be moved in unison.

12. The step-stool apparatus of claim 11, further comprising a biasing means connected to the platform and at least one of the legs in a manner that urges the legs to the stored position.

13. The step-stool apparatus of claim 11, further comprising a handle connected to at least one of the legs.

14. The step-stool apparatus of claim 11, further comprising a non-slip pad connected to the platform.

15. The step-stool apparatus of claim 11, further comprising a handle connected to at least one of the legs.

16. An apparatus comprising:
a set of two rails connected to a shopping cart and slidably connected to a platform, wherein the slidable connection between the rails and the platform is selected from the group consisting of rail and track systems, drawer slides, telescopic slides, and slidable bolt-assembly connections, and wherein the slidable connection between the rails and the platform enables the platform to have a stowed position and a deployed position, and wherein the shopping cart can nest with other shopping carts;
at least two legs hingedly connected to the platform;
a brace perpendicularly connected to each of the legs so that each of the legs is moved in unison; and
a handle perpendicularly connected to at least one of the legs.

17. The apparatus of claim 16, further comprising a bias member connected to the platform and at least one of the legs, wherein the bias member is selected from the group consisting of a spring, a gas cylinder, a gas strut, and an elastic.

18. The apparatus of claim 17, further comprising a non-slip pad connected to the platform.

19. The apparatus of claim 17, further comprising a tab connected to the platform.
